(19) United States
(12) Patent Application Publication
(10) Pub. No.: US 2025/0196311 A1
(43) Pub. Date: Jun. 19, 2025

(54) Power tool magnet accessory

(71) Applicant: Zachary Dunn, Nampa, ID (US)

(72) Inventor: Zachary Dunn, Nampa, ID (US)

(21) Appl. No.: 18/540,883

(22) Filed: Dec. 15, 2023

(51) Int. Cl. B25F 5/02

(52) U.S. Cl. CPC B25F 5/029

(57) ABSTRACT

A Power tool Magnet accessory is a magnetic tool holder that is attached to a power tool. It is used for holding fasteners, bits, or other small tool attachments. The magnet is held by a mounting structure with a spacer on the opposing side of the magnet. The magnet is spaced away from the power tool to provide battery and hand clearance. The assembly is designed to be attached to an impact driver, drill or similar power tool via the unused threaded belt hook connection point, or similar mounting element. This allows the user of the impact driver to temporarily attach and hold ferromagnetic fasteners, bits, or tools directly to the tool holder that is attached impact driver itself. This can often save space and increase safety and efficiency as the user now has convenient access to a small number of fasteners without having to reach beyond the tool itself.

### BACKGROUND OF THE INVENTION

### Field of the Invention

The disclosure relates to accessories for power tools, and more specifically, to bit holders and fastener holders for use with power tools.

### Background

The prior art relates to tool holders. Prior art tool holders may comprise armbands, neckbands, clips, and aprons having incorporated magnets for holding tools. What is lacking in the prior art is a tool holder comprising a spacer portion extending from a mounting structure that holds a magnet directly to the impact driver, but far enough away from the power tool as to allow for hand or battery clearance.

### SUMMARY OF THE INVENTION

A Power Tool Magnet Accessory is disclosed herein. The preferred embodiment of the disclosure comprises a generally round magnet portion with a hole in the center which is recessed into a mounting structure. This mounting structure has a spacer that extends from the side opposing the magnet portion. This spacer has a hole through the center as to allow a screw to pass through. This assembly is designed to attach to an impact driver, drill or similar power tool via the unused threaded belt hook connection point, or similar mounting element, oriented in a way that the mounting structure is holding the magnet away from the tool body, as to allow for battery and hand clearance.

This allows the user of the impact driver, drill, or similar power tool to temporarily attach and hold ferromagnetic fasteners, bits, or tools directly to the magnet on the impact driver itself. In this way, the user has a spot to hold fasteners directly on the tool that drives them, often saving space. Working this way can also increase work safety and efficiency due to not having to reach for fasteners. The tool can be used to aid in the cleanup of ferrous metal debris or spilled screws. The magnet accessory has proven useful for quickly retrieving ferrous metal screws from dirt, snow, sawdust, etc.

### BRIEF DESCRIPTION OF DRAWINGS

FIG. 1, top view of one embodiment 10, the magnet portion 16 sitting inside the mounting structure 14.

FIG. 2, bottom view of one embodiment 10, back side of the mounting structure 14 with spacer portion 20 extending.

FIG. 3, an embodiment of the disclosure 10, attached to an embodiment of a power tool 30.

FIG. 4, an embodiment of the disclosure 10, back side of the mounting structure 14 with spacer portion 20 extending.

FIG. 5, an embodiment of the disclosure 10, the magnet portion 16 sitting inside the mounting structure 14.

FIG. 6, an embodiment of the disclosure 10, attached to an embodiment of a power tool 30 with fasteners 31 temporarily attached.

FIG. 7, threaded belt hook connection point, or similar mounting element 60 shown on an embodiment of a power tool 30.

Before any embodiment of the invention are explained in detail, it is to be understood that the invention is not limited in its application to the details of construction and the arrangement of components set forth in the following description and should not be regarded as limiting. The invention is capable of other embodiments.

### DETAILED DESCRIPTION OF THE INVENTION

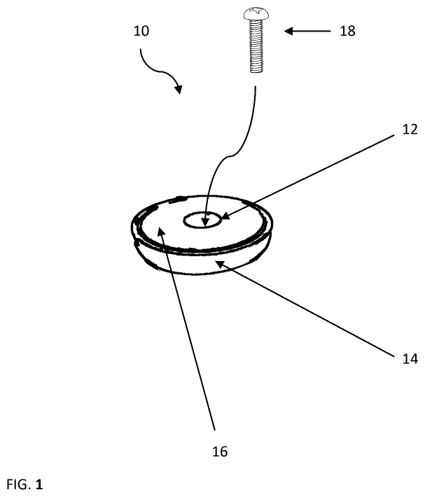

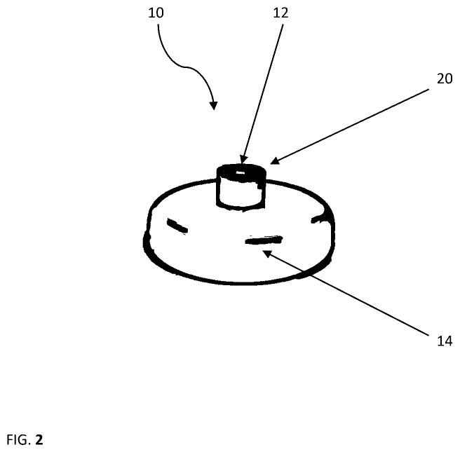

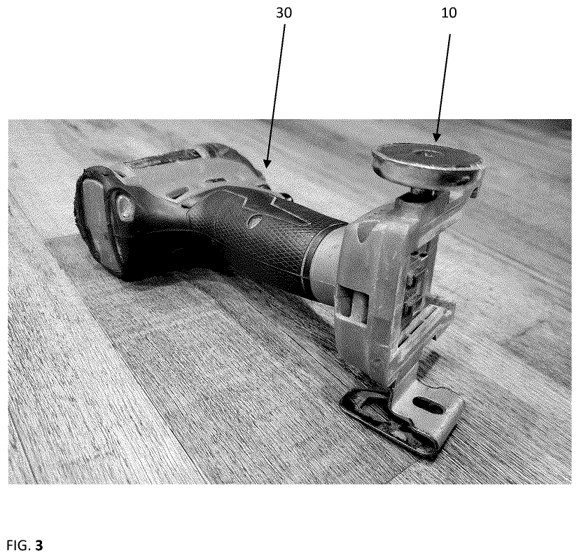

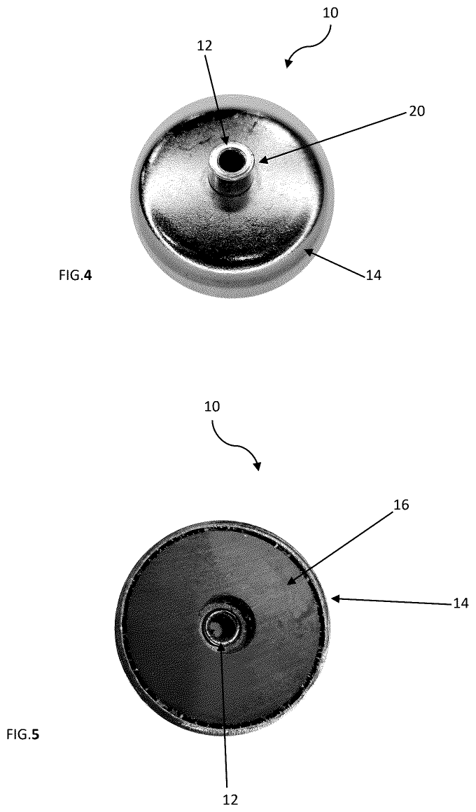

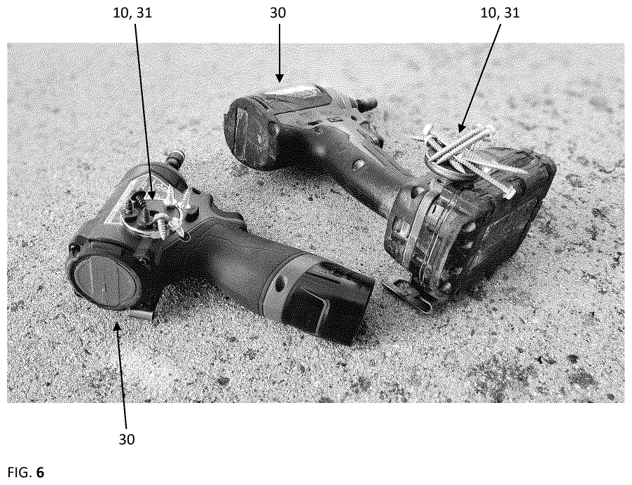

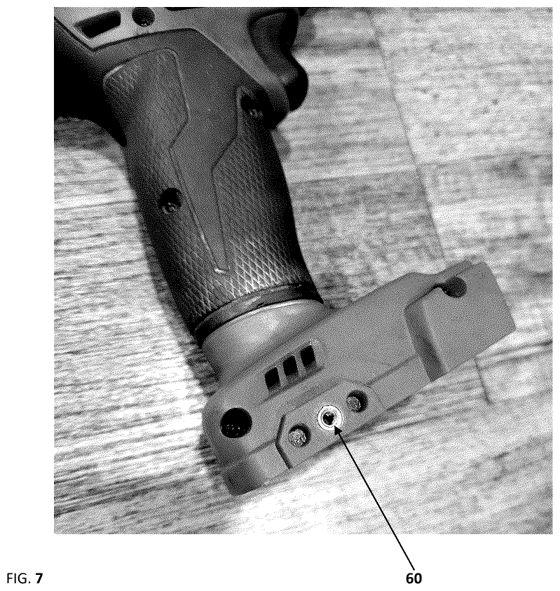

With reference to the drawings, particularly FIG. 1 and FIG. 2, a new tool holder embodying the principles and concepts of an embodiment of the disclosure and generally designated by the numeral 10 will be described.

The disclosure 10 is comprised of a generally round magnet portion 16 with a hole 12 in the center, which is attached to a mounting structure 14. This mounting structure 14 has a cylindrical spacer portion 20 extending from the side opposing the magnet portion 16. The spacer portion 20 has a hole 12 in the center, configured to allow a screw 18 to be used to attach the mounting structure 14 to an Impact driver or similar power tool 30. The tool holder 10 is to be attached to a power tool 30, with an appropriately sized fastener 18, via the unused threaded belt hook connection point 60, or similar mounting element.

The mounting structure 14 with magnet portion 16 is attached to a power tool 30, oriented in a way that the mounting structure 14 is holding the magnet portion 16 facing away from the power tool 30, as to allow for battery and hand clearance. This allows the user of the drill/impact driver to temporarily attach and hold ferromagnetic fasteners 31, bits, or small tools to the tool holder that is directly attached impact driver itself.

1. A tool holding device 10 comprising: a mounting structure 14 made of a metal, plastic, polymer or composite material, configured to hold a magnet portion 16; including a cylindrical spacer portion 20 extending from the mounting structure 14 opposite the magnet, the spacer portion 20 extending from the mounting structure has a hole 12 in the center, configured to allow a screw 18 to hold the assembly to a power tool 30 or similar tool; a magnet portion 16 comprising one or a plurality of magnets, configured to sit attached inside the mounting structure 14, to magnetically engage a ferromagnetic tool or fastener 31 brought into proximity, with a hole 12 in the center of the magnet portion configured to allow the mounting screw 18 to pass through the mounting structure 14.

2. The tool holding device 10 of claim 1, wherein the mounting structure 14 comprises a shell and spacer portion 20 made as one piece.

3. The tool holding device 10 of claim 1, wherein the mounting structure 14 comprises a shell and spacer portion 20 made as 2 pieces that are attached together with a rigid or flexible configuration to form the mounting structure 14.

4. The tool holding device 10 of claim 3, wherein the shell and spacer are two pieces and configured to connect via a quick connect system allowing the spacer to remain attached to the power tool.
